(19) United States
(12) Patent Application Publication
(10) Pub. No.: US 2025/0147297 A1
(43) Pub. Date: May 8, 2025

(54) AUTOMATIC OIL DISPENSER FOR MOUNTING ONTO AN OBJECTIVE IN AN INVERTED MICROSCOPE SYSTEM

(71) Applicant: Panacea Diagnostics Ltd, London (GB)

(72) Inventors: David R. Klug, London (GB); Joshua Arieh Shenker, London (GB)

(73) Assignee: Panacea Diagnostics Ltd, London (GB)

(21) Appl. No.: 18/832,578

(22) PCT Filed: Jan. 24, 2023
(86) PCT No.: PCT/GB2023/050152

§ 371 Date: Jul. 24, 2024

(30) Foreign Application Priority Data
Jan. 25, 2022 (GB) 2200918.7

(51) Int. Cl. G02B 21/33

(52) U.S. Cl. CPC G02B 21/33

(57) ABSTRACT

An automatic oil dispenser (10) for mounting onto an objective (14) in an inverted microscope system, the dispenser comprising: an outer annulus (52) configured to contact the objective to form a cavity; an inlet port (20) below the outer annulus (52) for inputting oil into the outer annulus (52); a pump for driving oil upwards through and out of the dispenser; an inner annulus (56) which tapers to an annular outlet (36); and a channel (53) connecting the two annuli such that oil fills the outer annulus (56), then the inner annulus (52) and then erupts through the outlet (36) onto an objective lens (26).

### FIELD OF THE INVENTION

The present invention relates to an automatic oil dispenser, and, in particular to an automatic oil dispenser for mounting onto an objective of an inverted microscope such that oil is automatically dispensed onto an objective lens.

### BACKGROUND TO THE INVENTION

In the field of Total Internal Reflection (TIR) microscopy, the angle of incidence must be above the critical angle in order to produce an evanescent field. With objective launched TIR, incidence angles greater than the critical angle are achieved by the use of objectives with high numerical aperture, such as oil immersion objectives. For TIR methods where the same objective is also used to collect light emission/scattering stimulated by the evanescent field, the high numerical aperture also assists with efficient collection of the emitted/scattered light.

In TIR microscopy, samples are often located on thin glass microscope slides/coverslips which are connected to the objective lens by a film of refractive index matching oil. The glass has to be thin in order that the short focal length of the objectives achieves focus at the upper glass surface.

Refractive index matching oil between the sample and the objective lens is used to achieve the incident angle required for imaging. For high-throughput imaging of multiple points or locations on a sample, the thickness of the index matching oil between the objective lens and the sample substrate must be maintained. Movement of the microscope system to image different points on a sample can cause the oil between the objective lens and the sample substrate to deplete largely through adhesion to the glass surface. Manually replenishing the index matching oil can cause interruptions to the apparatus during high-throughput imaging. Automatic oil feeding mechanisms are commercially available, and aim to automatically supply oil to an objective lens.

However, when coupled with high-throughput imaging systems, known automatic oil feeding systems have several shortcomings. For example, the sealing mechanism by which automatic oil dispensing systems seal onto a microscope objective are often the source of oil leaking pathways. In a high-throughput imaging system designed for non-expert use, even a small leak of oil into the microscope system can be detrimental.

Typically, automatic oil dispensing systems require excessive force and/or tools to enable assembly and/or disassembly of the oil dispensing device onto the microscope objective. This can cause damage to the objective lens and/or focusing system and hinder the efficiency of the imaging system. In order to dissemble the device from an objective lens, some systems require cutting or otherwise destructive removal of supply and return tubes from the device, which is not compatible with high throughput imaging or use and maintenance by non-experts.

Furthermore, other automatic oil dispensing systems do not provide a means for accurately locating the dispensing device at the correct height on the microscope objective, which can lead to an undefined thickness of oil between the substrate and the top of the objective lens. This can prevent the optical set up from achieving focus.

It is important to remove excess oil from a high throughput microscope system, to prevent leaking and/or spilling of oil into the microscope system. Although automatic oil dispensing systems may have features which enable the collection of excess oil, typically this oil is poorly syphoned back to the waste oil collector, which can cause oil to build up and leak within the microscope system.

Automatic oil feeding systems do not usually remove any excess oil which collects on the underside of a sample substrate, which can be a further source of oil leaking and/or dripping into the microscope system.

There is therefore a requirement for a device which can automatically dispense oil onto an objective lens and which can efficiently collect excess oil such that the thickness of the oil film between the objective lens and a sample can be maintained. The device must be compatable with a high-throughput imaging system, and must therefore be suitable for repeated use by non-experts whilst also being substantially free from oil leaks.

It is against this background that the present invention has arisen.

### SUMMARY OF THE INVENTION

According to the present invention there is provided an automatic oil dispenser for mounting onto an objective in an inverted microscope system, the dispenser comprising: an outer annulus configured to contact the objective to form an annular cavity; an inlet port below the outer annulus for inputting oil into the outer annulus; a pump for driving oil upwards through and out of the dispenser; a channel connecting the two annuli such that oil fills the outer annulus, then the inner annulus and then erupts through the outlet onto the objective lens.

The device of the present invention can be used to supply and maintain a thin film of refractive index matching oil between an objective lens of an inverted microscope and a sample substrate. The device of the present invention can be configured to fit around the objective lens of any inverted microscope system. The device of the present invention is compatible with total internal reflection microscopes in which maintaining a thin film of index matching oil is crucial. The device of the present invention can be used to automatically supply oil to an objective lens, and is therefore suitable for use in high-throughput imaging systems in which the system repeatedly moves to image multiple points on a substrate and which can cause the oil between the objective lens and a sample to otherwise deplete.

In some embodiments, the outer annulus directly contacts the objective to form an annular cavity. In some embodiments, the outer annulus may form a seal when it contacts the objective. In some embodiments, the outer annulus may be a lip seal. In some embodiments, the outer annulus contacts the objective to form an effective liquid seal during operation of the device, and therefore prevents oil from leaking into the microscope system. In some embodiments, the device may comprise multiple lip seals. In some embodiments, the outer annulus seals around the circumference of the objective without axial compression. In some embodiments the outer annulus provides an axial alignment of the device with the objective lens, which is separate from the sealing function. By providing an axial alignment of the device with the objective lens, the outer annulus may enable a better controlled oil film thickness between the objective lens and the sample substrate than other oil dispensing systems which have an undefined height between the device and the sample. The device of the present invention can form an oil meniscus over the objective lens with a controlled thickness, which can enable higher quality imaging.

In some embodiments, a low level of force may be required to fit the dispenser onto the objective, and to remove the dispenser from the objective. In some embodiments, the outer annulus can be fit onto the objective using a simple push and twist action. In such embodiments, the outer annulus provides a gentle, tool-free method for fitting the device onto the objective lens. This can be particularly advantageous, for example, when the objective lens is attached to a piezo element for focusing. This is because a piezo element can be easily damaged by application of the excessive forces which are typically required to assemble/disassemble other oil dispensing systems.

In some embodiments, the outer annulus forms an annular cavity between the objective and dispenser, which is filled with oil when the device is in operation. In some embodiments in which the outer annulus is a lip seal, the annular cavity is created behind the rubber lip of the lip seal.

In some embodiments, the annular cavity forms part of the feed system delivering oil from the inlet port to the objective lens. In some embodiments, as oil enters the annular cavity, the oil path splits, and travels around the annular cavity in opposite directions. In some embodiments, the dispenser comprises an inner annulus which tapers to an annular outlet or aperture in a plane perpendicular to the annular plane. In some embodiments, a channel connects the inner and outer annuli such that oil fills both annuli before erupting onto the objective lens as it exits the aperture.

In some embodiments, the filling in series of the two annuli between the inlet port and the objective lens is important for achieving an eruption of oil from the annular outlet and a bubble free meniscus of oil over the objective lens. This contrasts other known devices which comprise a singular annular channel between the inlet port and the objective lens, and in which the oil fills only a singular volume before contacting the objective lens. In some embodiments, the annular outlet is a narrow annular gap which acts as a bubble prioritiser as oil is forced through. In some embodiments, the tapering of the inner annulus facilitates air being purged from the system during priming. In some embodiments, the tapering of the inner annulus facilitates a bubble free-meniscus of oil to be formed over the objective lens.

Within the context of the present invention, the term “erupting” should be understood to include any dispensing of the oil onto the objective lens in which the oil moves from below in a substantially upward motion. In some embodiments, the inlet port is located below the outer annulus which forms the annular cavity, and the pump drives oil upwards within the dispenser to facilitate the eruption of the oil onto the objective lens. This is in contrast to devices in which the inlet port is located above the oil feeding system and oil is fed to the objective lens via a gravity-led feeding system such as pouring or drip feeding. In some embodiments, the eruption of oil is key to efficiently purge air from the device, and to ensure a bubble-free meniscus is formed over the objective lens.

In some embodiments, the channel may be located diametrically opposite the inlet port. In some embodiments, the channel may be located at the opposing point along the outer annulus, to a point at which oil enters the outer annulus.

In some embodiments, the two annuli are separated by the objective crown except for directly opposite the point at which oil enters the annular cavity, where a channel connects the two annuli. In some embodiments, the channel is a machined feature through the bounding wall of the two annuli. In some embodiments, the channel being located opposite the point at which oil enters the annular cavity ensures air can be efficiently purged from the device. In some embodiments, as oil enters the annular cavity, it splits into two oil fronts which flow around the annular cavity in opposite directions. In some embodiments, the movement of the oil fronts and the channel being directly opposite the entry point of the oil into the annular cavity, ensures air moves through the annular cavity and through the channel prior to the oil moving through. In some embodiments, this prevents air bubbles from forming in the oil and ensures a bubble-free meniscus of oil can be formed over the objective lens. The device of the present invention provides a controlled pathway for the oil to be delivered to the objective lens, which is in contrast to other devices in which oil is sprayed or introduced between the sample and objective lens using jets, in a relatively uncontrolled manner.

In some embodiments, the dispenser may further comprise an internal channel fluidically connecting the inlet port and the outer annulus.

In some embodiments, the internal channel may extend radially and axially through the device. In some embodiments, the internal channel may extend radially and axially through the dispenser. This is in contrast to other automatic oil dispensing devices which typically have internal channels extending in only one direction. In some embodiments, an internal channel which extends both radially and axially through the device enables the oil to enter the device at a lower point to where it enters the outer annulus, and enables the device to be filled from the side. An internal channel geometry which enables the device to be filled from the side can be advantageous because oil ports located on the bottom of the device may be inaccessible when in use.

The geometry of the internal channel with the inlet port below the point of at which the oil is dispensed onto the objective lens, facilitates the erupting motion of the oil. This configuration and the active pumping of the oil may be a more efficient method of providing oil to the objective lens and removing excess oil from the objective lens. This is in contrast to other devices in which the inlet port must be above the outlet port to facilitate liquid being dripped or poured onto a top lens surface of an immersion objective. In other devices, oil may be injected or squirted from the side external to the oil dispensing device, which is a relatively uncontrolled method for dispensing oil onto the objective lens.

In some embodiments, the internal channel may be formed by drilling at least one hole in the dispenser. In some embodiments, the internal channel may be formed by drilling at least two holes in the dispenser. In some embodiments, the internal channel may be formed by drilling at least three holes in the dispenser. In some embodiments, an internal channel fabricated by drilling holes in the body of the device facilitates an internal channel which extends both radially and axially through the device.

In some embodiments, the internal channel may comprise at least one cap. In some embodiments, one or more of the holes forming the internal channel may be capped at one of their ends. In some embodiments, grub screws may be used to cap one or more of the holes. In some embodiments, the grub screws may be stainless-steel.

In some embodiments, capping the one or more holes at one end can be used to form a continual oil path from the inlet port, axially up through the body of the device, and then radially in towards the centre where oil enters the annular cavity via a hole in the outer annulus. In some embodiments, by forming an internal channel by drilling holes, the body of the device can be substantially made from one piece of material, which is advantageous over forming channels in multiple parts, as it ensures a leak-free device.

In some embodiments, the dispenser may be 100 to 300 μm lower than the objective lens when mounted onto the objective. In some embodiments the dispenser may be more than 100, 125, 150, 175, 200, 225, 250 or 275 μm lower than the objective lens when mounted onto the objective. In some embodiments, the dispenser may be less than 300, 275, 250, 225, 200, 175, 150 or 125 am lower than the objective lens when mounted onto the objective. In some embodiments, it may be preferable for the dispenser to be 300 μm lower than the objective lens when mounted onto the objective for ease of manufacturing the part. In some embodiments, the height measurement has a tight tolerance of less than 100 μm.

In some embodiments, the objective lens protrudes through the annular outlet and is proud of both the dispenser body and the V-seal. In some embodiments, the height of the dispenser relative to the objective is determined by a controlled machined face which the objective presses up against. In some embodiments, the controlled machined face requires the tightest of tolerances (<100 μm) from a datumed feature to which multiple features are referenced. In some embodiments, by providing a controlled machined face, the z height of the dispenser can be repeatably and reliably controlled. In some embodiments, the controlled machine face of the dispenser facilitates the dispenser being easily located at the correct height on the objective.

In some embodiments, the height of the dispenser relative to the objective determines the thickness of the oil film deposited over the objective lens. In some embodiments, by providing the dispenser at an accurately controlled height relative to the objective, the thickness of the oil film can be reliably controlled. This in contrast to other automatic oil dispensing devices which do not provide a means for accurately controlling the height of the dispenser when mounted onto the objective, and consequently have an uncontrolled oil film thickness.

In some embodiments, by providing a means to accurately control the height of the dispenser on the objective, the dispenser can be prevented from clashing with the sample substrate.

In some embodiments, the dispenser may further comprise an automatic oil removal device comprising:
a surface for contacting the objective lens, wherein the surface has a rounded outer edge such that oil flows from the objective lens over the edge of the surface;
a gulley around the circumference of the device that catches the oil flowing from the surface of the device; and
a drainage point through which the oil is drained, wherein the gulley is angled towards the drainage point.

In some embodiments, the dispenser may further comprise:
a surface for contacting the objective lens, wherein the surface has a rounded outer edge such that oil flows from the objective lens over the edge of the surface;
a gulley around the circumference of the device that catches the oil flowing from the surface of the device; and
a drainage point through which the oil is drained, wherein the gulley is angled towards the drainage point.

In other words, the oil removal functionality may be provided by the dispenser, rather than by a dedicated automatic oil removal device.

In some embodiments, the device of the present invention may be compatible for use with microscope systems which move in multiple directions. In some embodiments, the device of the present invention is compatible for use with imaging systems using a multi-axis controlled stage or any other devices or apparatus that are capable of providing motion. In some embodiments, the substrate may be mounted on a multi-axis controlled stage, where the multi-axis motion controlled stage can be configured to provide a motion and move the substrate into any desired position. The multi-axis controlled stage also allows the sample to be moved across the objective lens rapidly. In some embodiments, the multi-axis controlled stage may be an X, Y axis or an X, Y, Z controlled stage.

In some embodiments, the gulley extends around the entire circumference of the device, enabling excess oil flowing from any direction away from the objective lens, to be captured in the gulley. Other automatic oil dispensing devices may collect oil from a single point in the device, and are limited to movement in a single direction.

In some embodiments, the gulley is angled towards a drainage point, and the drainage point is located at the lowest point of the gulley. In some embodiments, the gulley is angled around the entire circumference of the device towards the drainage point.

In some embodiments, the device may comprise a single drainage point in fluid connection with the outlet port. In some embodiments, the device may comprise multiple drainage points in fluid connection with the outlet port. In some embodiments, it may be beneficial for the device to comprise a single drainage point because it ensures that there is only one point of negative pressure within the device. In some embodiments, having a single drainage point is easier to maintain coverage with oil. In some embodiments, it is easier to balance suctioning oil out of a single drainage point, such that pooling of the oil is prevented.

In some embodiments, in which the device moves relative to the imaged sample, the rounded edge of the surface of the device enables excess oil to flow from the objective lens, over the gradient surface of the device, and towards the angled gulley. The angled gulley may then direct the overflow oil towards the drainage point at the lowest point of the gulley.

In some embodiments, the rounded edges of the surface of the device enable a break in the surface tension between the oil film and the glass slide, enabling the oil to fall away from the microscope slide and into the gulley.

In some embodiments, the surface of the device is rounded around its entire circumference, which facilitates excess oil being captured by the gulley in all directions.

In some embodiments, the gradient of the rounded edge is 7.5 to 12.5° incline from horizontal. In some embodiments, the gradient of the rounded edge is more than 7.5, 8.5, 9.5, 10.5 or 11.5° incline from horizontal. In some embodiments, the gradient of the rounded edge is less than 12.5, 11.5, 10.5, 9.5 or 8.5° incline from horizontal. In some embodiments, it may be preferable for the gradient of the rounded edge to be at least 11° incline from horizontal.

In some embodiments, the dispenser may further comprise an outlet port.

In some embodiments, the outlet port may be fluidically connected to the drainage point. In some embodiments, oil is moved through the exit port by active pumping.

In some embodiments, the inlet and the outlet ports may be threaded. In some embodiments, the inlet port and the outlet port may be threaded.

In some embodiments, a threaded inlet and outlet port can be used for a removable leak-free connection of tubing to the dispenser. In some embodiments, threaded inlet and outlet ports enable tubing to be attached and/or removed from the dispenser in a reusable manner, and prevents the tubing from having to be cut when removing the dispenser from the objective.

In some embodiments, the surface of the device may have a single plane of symmetry.

In some embodiments, a device comprising a top surface with a single plane of symmetry is important for the efficient removal of excess oil from the surface of the device and the objective lens. In some embodiments, the device has a single plane of mirror symmetry so that excess oil flowing in any direction moves towards the outlet of the device under gravity.

In some embodiments, the gulley may be bound by at least one V-seal.

In some embodiments, at least one V-seal provides a boundary to the gulley, preventing oil from spilling from the gulley into the microscope system. In some embodiments, the gulley is bound by the inner surface of the V-seal.

In some embodiments, a glass microscope slide may be placed over the objective lens to image a sample thereon. In this embodiment, an oil film forms between the device and the glass before a domed meniscus is able to take shape. In some embodiments, oil is pumped through the device, and exits onto the objective lens via the aperture in the tapered annular cavity. In some embodiments, as more oil is pumped, the oil film thickens enough to contact the glass slide, and the oil “wets” the glass slide before being drawn across the objective lens, first as a crescent shape, and then eventually as a complete circle.

In some embodiments, the height of the V-seal can affect the thickness of the oil film formed between the glass slide and the objective. In some embodiments, the V-seal is in clearance with the glass slide. In some embodiments, the height of the V-seal is defined and may be 0.1 to 0.5 mm from the glass slide. In some embodiments, the height of the V-seal may be more than 0.1, 0.2, 0.3 or 0.4 mm from the glass slide. In some embodiments, the height of the V-seal may be less than 0.5, 0.4, 0.3 or 0.2 mm from the glass slide. In some embodiments, a minimum distance of 0.1 mm is required to maintain a clearance between the V-seal and the glass slide. In some embodiments, there is a maximum distance of 0.5 mm between the V-seal and the glass slide to ensure the V-seal scrapes excess oil from the glass slide. This is in contrast to other automatic oil dispensing systems, which commonly have an undefined height between the oil dispensing device and the sample, and which can prevent the optical set up from achieving focus.

In some embodiments, the V-seal may also provide a wiping function. In some embodiments, the V-seal may wipe any large residual oil drops from the underside of the sample substrate. This is in contrast to other devices which may possess an annular V-shaped channel merely for catching oil that spills into the gulley, but lack a wiping function.

The wiping function is important, since oil collecting and dripping into the microscope system can be detrimental to the system, particularly in a high-throughput device. In some embodiments, when the relative movement between the device and the sample is equal to or greater than the radius of the V-seal, excess oil remaining on the underside of the sample is captured by the V-seal, where it is directed into the gulley and then to the drainage point.

In some embodiments, as the V-seal is in clearance with the glass slide, not all the oil will be swept up and a thin film remains. In some embodiments, the remaining oil on the underside of the substrate may thicken over time with movement of the device, and could potentially form larger droplets of oil on the outer surface of the V-seal. In some embodiments, a secondary V-seal may collect any excess oil wiped from the outside of the primary V-seal, and catches it within the secondary V-seal. In some embodiments, this may be a low volume of oil. In some embodiments, the secondary V-seal is a disposable element which enables it to be regularly replaced as necessary.

In some embodiments, the at least one V-seal may be disposable. In some embodiments, the at least one V-seal may be rubber. In some embodiments the V-seals are easy to fit onto the device and are stretched over the device. Therefore in some embodiments, the V-seals are easy to regularly replace ensuring they are compatible for use in a high-throughput imaging system.

In some embodiments, the dispenser may further comprise an O-ring.

In some embodiments, the device may comprise a plain O-ring. In some embodiments, the O-ring may rest on the surface of the device, in clearance of the objective lens, to create a slightly enclosed pool of oil around the objective lens. In some embodiments, the O-ring creates a slightly enclosed boundary to maintain an oil film. In some embodiments, it may be beneficial for the device to comprise an O-ring if oil is being pumped between the objective and a sample with breaks in the surface, such as multiple microscope glass slides.

In some embodiments, without an O-ring, the device may not maintain the thin film of oil between the objective and the glass slide.

In some embodiments, the device comprising an O-ring may be advantageous if the microscope system is moving quickly. In some embodiments, in which an oil film is formed between a glass slide and the objective, as the glass slide and the objective move relative to one another, the oil film is stretched and pulled, therefore requiring additional pumping of oil to maintain oil film thickness. In some embodiments, the addition of the O-ring on the surface of the device may help to maintain this oil film at higher relative velocities. In some embodiments, the O-ring may prevent the oil film from being ripped away from the sample and the objective. In some embodiments, not using an O-ring may limit the speed in which the microscope can be moved.

In some embodiments, it may be beneficial to use the dispenser without an O-ring, because an O-ring may increase the trapping of air-bubbles and/or contaminants, and prevent them being wicked away from the objective lens.

In some embodiments, the body of the dispenser may be substantially a single piece of material.

In some embodiments, the body of the device may be made from a single piece of machined plastic. In some embodiments, the body of the device may be made from polyether ether ketone (PEEK). In some embodiments, it may be beneficial to manufacture the body of the device from machined plastic because it is important for the device to be lightweight. In some embodiments, the objective onto which the device is fitted may be attached to a piezo element for example. In some embodiments, placing a heavy device onto a piezo element may limit the response time of the piezo element. In some embodiments the body of the device may be substantially a single piece of metal. In some embodiments, the lip seals and V-shaped seals can be attached to the single machined body piece by gently stretching the seals over the device. In some embodiments, the V-shaped seals and/or lip seals are sized such that they can easily fitted and removed from the single machined body piece, to facilitate replacement of the seals and maintenance of the device. In some embodiments, the dispenser can be attached to the objective via the outer annulus using a simple, gentle push and twist action. This is in contrast to known devices in which fasteners such as bolts, tools and excessive force are required to connect structures together which could damage the objective. In some embodiments, by requiring only a single machined piece, the dispenser is more cost effective to produce, easier to assemble and simpler to install compared to known devices.

### FIGURES

The present invention will now be described, by way of example only, with reference to the accompanying figures in which:

FIG. 1 shows a split-view of the device of the present invention, assembled onto a microscope objective;

FIG. 2 shows an isometric view of the device of the present invention, assembled onto a microscope objective;

FIG. 3 shows a top view of the device of the present invention, assembled onto a microscope objective and comprising an O-ring;

FIG. 4 shows the inner oil pathway within the device;

FIG. 5 shows the inner oil pathway within the device when assembled onto a microscope objective;

FIGS. 6A to 6G show the oil pathway within the device, and the formation of a bubble free meniscus;

FIGS. 7A to 7F show the formation of an oil film between the objective and a glass microscope slide;

FIG. 8 shows the angled gulley used to collect and drain excess oil;

FIGS. 9A and 9B show excess oil being scraped from the underside of a glass microscope slide by a V-seal;

FIG. 10A shows the device of the present invention mounted onto a microscope objective; and

FIG. 10B shows a detailed view of the objective protruding above the device.

### DETAILED DESCRIPTION

The device of the present invention can be used to supply and maintain a thin film of refractive index matching oil between an objective lens and a sample substrate. The device of the present invention is suitable for use an inverted microscope system and for high-throughput imaging. Devices for the automatic dispensing of oil onto an objective lens known in the art have several shortcomings which hinder their compatibility with high-throughput imaging systems. For example, devices known in the art require tools and/or excessive forces to assemble and/or disassemble the device to the microscope objective, require tubes to be destructively removed in order to remove the device from the microscope objective, provide inferior sealing such that oil leaks into the rest of the microscope system, or provide an undefined height between the device and a sample being imaged, such that the microscope cannot achieve a sufficient focus. In addition, prior art devices typically lack an efficient oil removal system in which excess oil is syphoned back to the waste collector, and in which oil is removed from the underside of the sample to prevent it collecting within the microscope system.

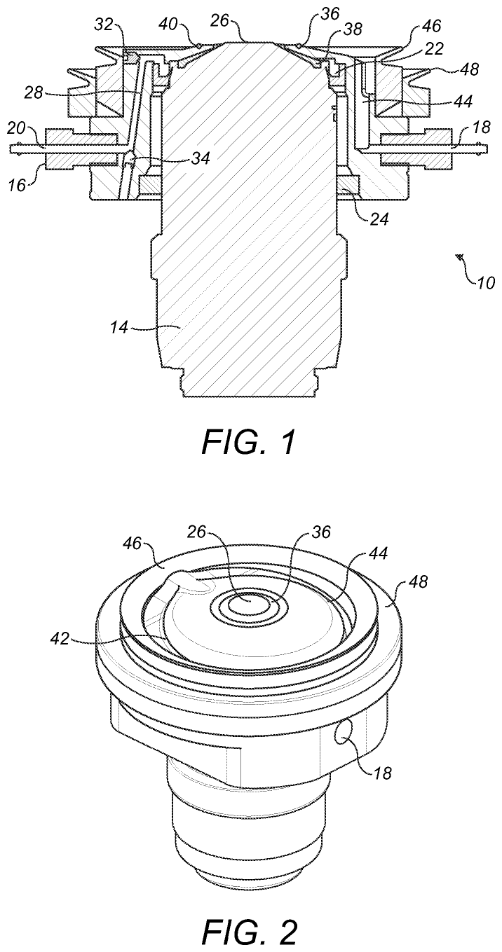

Referring to FIG. 1, the device 10 of the present invention is shown. FIG. 1 shows the device 10 fit around a TIRF 60× Objective Microscope lens from Nikon 14, although the device 10 of the present invention is compatible to fit around the objective of any inverted microscope system. The body 16 of the device 10 is made from a single piece of machined material. The material may be any suitable material such as PEEK or a metal for example. This ensures a leak free construction. The outlet port 18 and inlet port 20 are threaded such that tubing can be easily attached and removed from the device, and to ensure the connections are substantially leak-free. As shown in FIG. 1, the internal geometries of the device 10 fit around the objective 14. Two lip seals 22 and 24 contact the outer body of the objective 14, forming a liquid-seal. The lip seals 22 and 24 must be compatible with both the indexing oil and any cleaning fluids used to clean the device. The lip seals may be made of rubber. The lip seals 22 and 24 also provide an axial alignment of the device 10 with the objective 14, which enables an oil film to be formed between the objective lens 26 and the sample, with a precisely controlled thickness. This aids the optical system in achieving focus and improves imaging quality. The lip seals 22 and 24 require a simple, gentle push and twist to fit the device 10 onto the objective 14, and therefore the device 10 can be attached to the microscope objective 14 without the use of tools and excessive force.

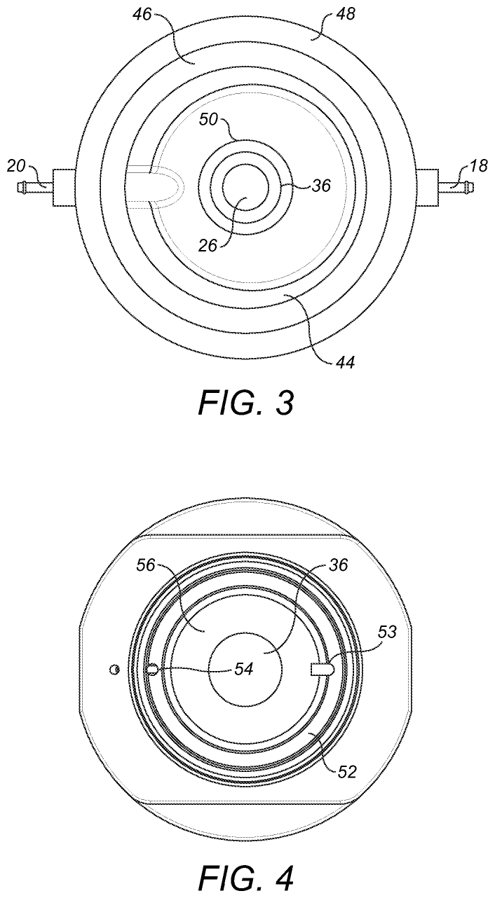

An internal channel 28 extends from the inlet port 20 up through the body of the device 16 where it opens into an annular cavity 52 (shown in FIG. 4) formed behind the rubber lip of the lip seal 22. The internal channel 28 shown in FIG. 1, is made by drilling three holes into the body 16 of the device 10. These holes are capped by two grub screws 32 and 34, which create a continuous channel extending radially and axially through the body 16 of the device 10. The grub screws 32 and 34 may be stainless steel.

The device 10 comprises an inner annulus 56 which is separated from the annular cavity 52 by the objective distal crown 38, except at the location of a connecting channel 53 (shown in FIG. 4). The inner annulus 56 tapers to an annular outlet 36, through which oil erupts onto the objective lens 26. Optionally, the device may be provided with an O-ring 50 which facilitates the maintenance of the oil film over the objective lens.

Referring to FIG. 2, the device is further provided with a gulley 42 which extends around the entire circumference of the device 10. The surface of the device has a geometry with a single plane of symmetry whereby the oil can freely flow away from the objective lens 26 in all directions. The gulley 42 is angled towards a single drainage point 44, wherein the single drainage point 44 is located at the lowest point of the gulley 42. The single drainage point 44 is in fluid connection with the outlet port 18. The gulley 42 is bound by an outer rubber V-seal 46. The V-seal 46 provides two functions, the first is to provide the boundary to the gulley 42, and the second function is to provide a wiping action of any large residual oil drops on the underside of the imaged sample. A secondary external V-seal 48 is utilised to collect any unwanted oil collecting on the outside of the primary V-seal 46 and prevents the oil collecting elsewhere within the microscope system.

FIG. 2 illustrates the device without an O-ring 50, which may be preferred for maximum removal of air bubbles and contaminants from the oil film. Alternatively, the device may comprise a plain O-ring 50, as shown in FIG. 3, which rests on the top surface of the device 10, in clearance of the objective lens 26. The O-ring 50, creates a slightly enclosed pool of oil around the objective lens 26, which can be beneficial when there are gaps between the objective and the sample such as when using multiple microscope glass slides. The O-ring 50 can therefore minimise oil being lost from between the objective lens 26 and the sample.

Referring to FIG. 4, a detailed view of the oil path within the device 10 is shown. Opposite the point 54 at which oil enters the annular cavity 52, a channel 53 is located. The channel 53 fluidically connects the annular cavity 52 and the inner annulus 56 by forming a gap through which oil can flow. The annular cavity 52 is otherwise sealed by the objective crown 38 which prevents oil from entering the inner annulus 56 at any other point besides the channel 53. The channel 53 being located opposite the point 54 at which oil enters the annular cavity 52 ensures that oil fills both annuli 52 and 56, before erupting onto the objective lens 26 via the annular outlet 36 formed by the tapering of the inner annulus 56.

This enables air to be purged from the oil, and ensures a bubble-free meniscus forms over the objective lens 26.

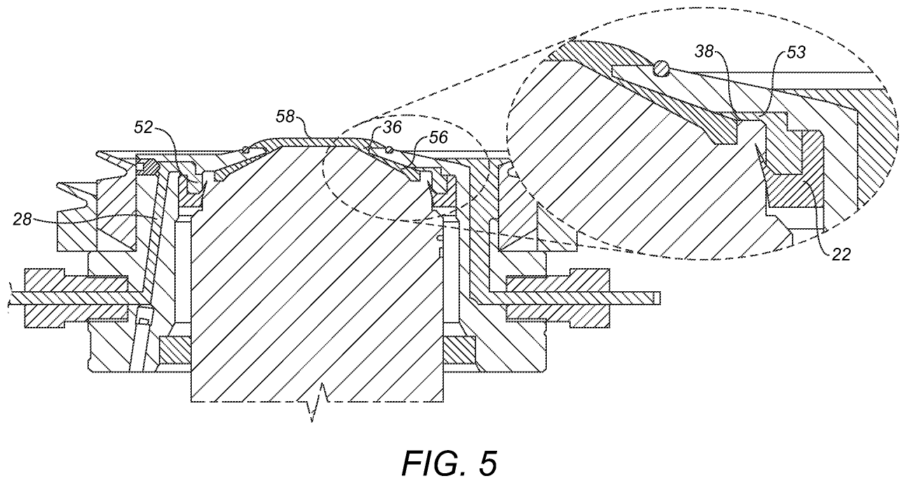

Referring to FIG. 5, a detailed view of the oil path within the device 10 is shown. The oil enters the annular cavity 52 behind the rubber lip of the lip seal 22 from the internal channel 28. As the oil enters the annular cavity 52, the oil path splits into two fronts, which travel around the annular cavity 52 in different directions. The two oil fronts then collide at the opposing point in the annular cavity 52, aligning with the channel 53. The gap created by the channel 53 enables the oil to travel through to the inner annulus 56, which is otherwise separated from the annular cavity 52 by the objective crown 38. As shown in FIG. 5, the inner annulus 56 tapers from the annular cavity 52 towards the objective lens 26. The tapered channel 56 ends in an annular outlet 36, through which the oil is forced. The annular outlet 36 is a narrow annular gap, and as the oil is forced through the narrow gap, air is purged from the system during priming, allowing a bubble free oil meniscus 58 to form over the objective lens 26.

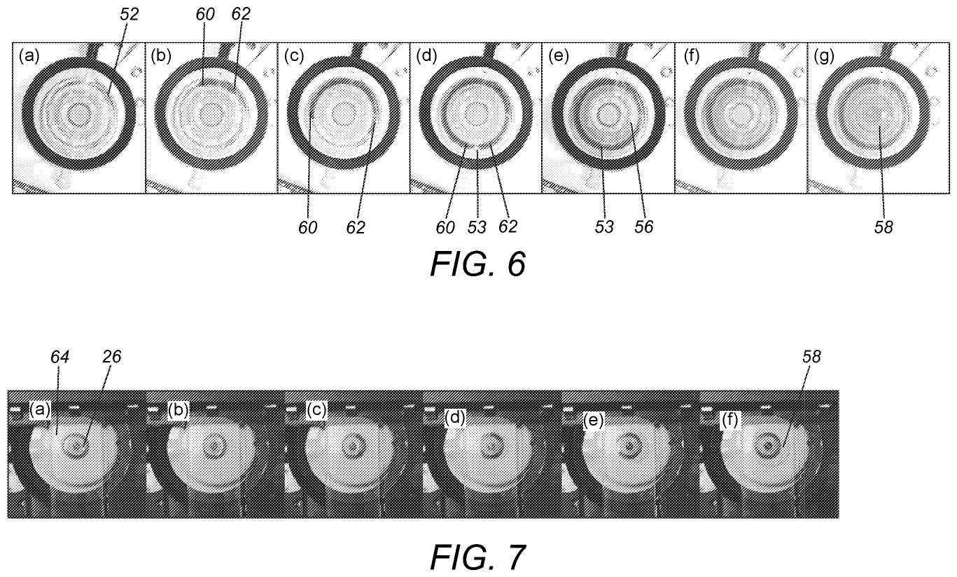

The splitting of the oil fronts within the annular cavity 52 and the advancement of the two oil fronts 60 and 62 is illustrated in FIGS. 6A to 6D. FIGS. 6E to 6G show the two oil fronts 60 and 62 colliding at the channel 53 and entering the inner annulus 56 before forming a bubble free meniscus 58 over the objective lens 26.

Referring to FIG. 7, a glass microscope slide 64 may be placed over the objective lens 26 when imaging a sample located thereon. When a glass slide 64 is situated over the top of the objective lens 26, an oil film forms between the objective lens 26 and the glass microscope slide 64 before a domed meniscus 58 is able to take shape. The oil film shown in FIGS. 7A and 7B forms as oil is pumped through device and exits onto the objective lens 26 via the annular outlet 36. As more oil is pumped through the device 10, the oil film on the objective lens 26 grows thick enough that it is able to contact the glass slide 64 and the oil “wets” the glass slide 64. As shown in FIGS. 7C to 7E, the oil is then drawn across the objective lens 26, first as a crescent shape, and then eventually as a complete circle. The device 10 may form part of a high-throughput imaging system which moves around a sample, imaging multiple points. For example, the device may be used to maintain the level of index refracting oil in a system scanning an entire multi-well chip containing multiple spots in each well. The oil film may be stretched and pulled as the glass slide 64 and objective lens move relative to one another. Therefore additional pumping of oil may be required to maintain the meniscus 58 and to maintain the oil film contacting the glass slide as shown in FIG. 7E. The addition of an O-ring 50 on the top surface of the device 10 may also help to maintain this oil film when the glass slide 64 is moved at higher relative velocities.

The device 10 is compatible for use in an imaging system in which the sample is moved in any direction, relative to the device 10. Referring to FIG. 8, a detailed view of the gulley 42 and the system for excess oil collection and drainage is shown. The relative movement between the device 10 and the imaged sample can cause excess oil to flow away from the objective lens 26 in any direction. The rounded edges of the gradient surface 66 of the device 10 breaks the surface tension between the oil film and the sample, enabling the excess oil to flow towards the angled gulley 42. The angled gulley 42 then directs overflow oil towards a single drainage point 44 which is situated at the lowest point of the gulley 42. The device 10 has a single plane of mirror symmetry so that excess oil flowing in any direction eventually moves towards the single drainage point 44 under gravity. The gulley 42 is bounded by the inner surface of the primary V-seal 46 so that the gulley 42 can hold a volume of excess oil without spilling or smearing elsewhere within the microscope system. When the relative movement between the device and the sample is equal to or greater than the radius of the primary V-seal 46, excess oil remaining on the underside of the sample is captured by the V-seal's inner wiping surface 68 and is also directed to the gulley 42 and the single drainage point 44.

When a glass microscope slide 64 is placed on top of the objective lens 26, the V-seal 46 is in clearance with the glass slide 64 so that not all the oil is wiped when the glass slide 64 is moved relative to the device 10. A thin film of oil remains on the underside of the glass slide 64. Over time this remaining thin film of oil can potentially thicken and form larger drops. These drops can collect inadvertently on the outside 70 of the primary V-seal 46. The secondary V-seal is necessary to prevent the drops collecting on the outside 70 of the primary V-seal from leaking into the microscope system. The function of the secondary V-seal 48 is therefore to collect the very low volumes of oil wiped in this manner.

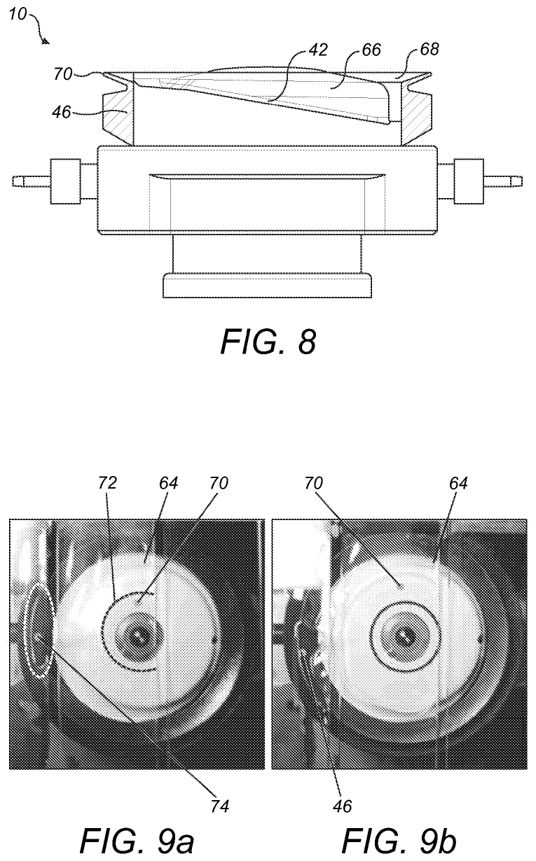

Referring to FIG. 9, an oil film formed between the objective lens 26 and a glass slide 64 is shown. The oil film is sufficiently thick that it contacts the glass slide 64 forming a contact region 72. Excess oil on the underside of the glass slide 64 forms a thick drip of oil 74, which can be scraped by the V-seal 46 as shown in FIG. 9B.

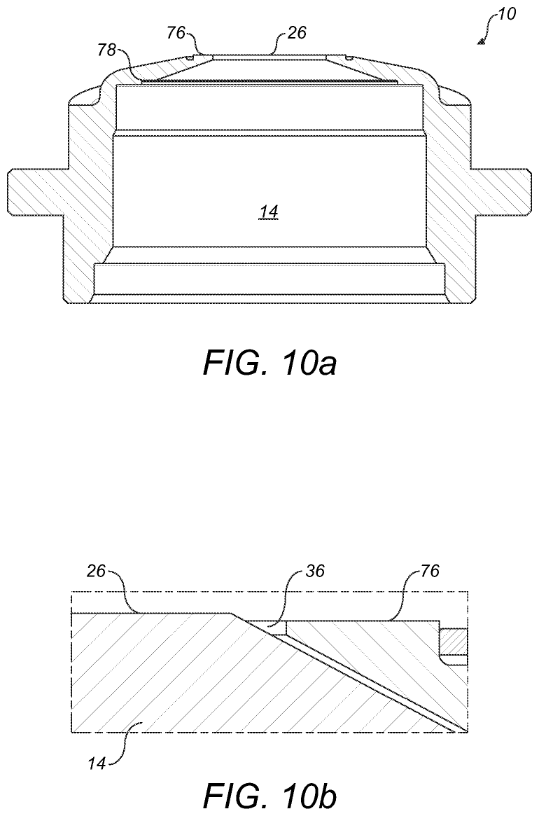

Referring to FIG. 10, when mounted onto the microscope objective 14, the device 10 is 100 μm to 300 μm lower than the objective lens 26. The device 10 may be 300 am lower than the objective lens 26 for ease of manufacture. This measurement has a tight tolerance of less than 100 μm to ensure that the height of the device 10 can be repeatably and reliably controlled. As shown in FIG. 10A, in order to achieve the accurately controlled height, the device 10 comprises a datum face 76 to which multiple features are referenced. For example, the dimension of the mating face 78 is measured from the datum face 76 and must have a tight tolerance of less than 100 μm.

Accurately controlling the height of the device 10 with respect to the microscope object 14 is important to prevent to prevent the device 10 from clashing with a sample substrate mounted above. As shown in FIG. 10B, the objective lens 26 protrudes through the annular outlet 36 and sits proud of the device 10. The height of the device 10 controls the thickness of the oil film deposited onto the objective lens 26. Therefore, accurately and reliably controlling the height of the device 10 also ensures the thickness of the oil film is reliably controlled.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1: An automatic oil dispenser for mounting onto an objective in an inverted microscope system, the dispenser comprising:
an outer annulus configured to contact the objective to form a cavity;
an inlet port below the outer annulus for inputting oil into the outer annulus;
a pump for driving oil upwards through and out of the dispenser;
an inner annulus which tapers to an annular outlet; and
a channel connecting the two annuli such that oil fills the outer annulus, then the inner annulus and then erupts through the outlet onto an objective lens.

2: The dispenser according to claim 1, wherein the channel is located diametrically opposite the inlet port.

3: The dispenser according to claim 1, further comprising an internal channel fluidically connecting the inlet port and the outer annulus.

4: The dispenser according to claim 1, further comprising an internal channel that extends radially and axially through the dispenser to fluidically connect the inlet port and the outer annulus.

5: The dispenser according to claim 1, further comprising an internal channel formed by drilling at least one hole in the dispenser in order to fluidically connect the inlet port and the outer annulus.

6: The dispenser according to claims 3 to 5, further comprising an internal channel which comprises at least one cap.

7: The dispenser according to claim 1, wherein the dispenser sits 150 to 300 μm lower than the objective lens when mounted onto the objective.

8: The dispenser according to claim 1, further comprising:
a surface for contacting the objective lens, wherein the surface has a rounded outer edge such that oil flows from the objective lens over the edge of the surface;
a gulley around the circumference of the device that catches the oil flowing from the surface of the device; and
a drainage point through which the oil is drained, wherein the gulley is angled towards the drainage point.

9: The dispenser according to claim 1, further comprising an outlet port.

10: The dispenser according to claim 9, wherein the inlet port and the outlet port are threaded.

11: The dispenser according to claim 1, wherein the surface of the device has a single plane of symmetry.

12: The dispenser according to claim 8, wherein the gulley is bound by at least one V-seal.

13: The dispenser according to claim 1, further comprising an O-ring.

14: The dispenser according to claim 1, wherein the body of the dispenser is substantially a single piece of material.
